(19) United States
(12) Patent Application Publication
(10) Pub. No.: US 2005/0060425 A1
(43) Pub. Date: Mar. 17, 2005

(54) Application-based autonomic connectivity

(75) Inventors: James Tein-Chang Yeh, Beijing (CN); Hui Su, Beijing (CN)

Correspondence Address: IBM CORPORATION, T.J. WATSON RESEARCH CENTER, P.O. BOX 218, YORKTOWN HEIGHTS, NY, 10598, US

(73) Assignee: International Business Machines Corporation, Armonk, NY (US)

(21) Appl. No.: 10/881,380

(22) Filed: Jun. 30, 2004

(30) Foreign Application Priority Data
Jul. 1, 2003 (CN) 03148280.5

(51) Int. Cl. G06F 15/16

(52) U.S. Cl. 709/232; 709/228

(57) ABSTRACT

Systems, apparatus and methods, which can select in real time and dynamically, an ISP and network adapter etc., appropriate for the particular application being currently used by a user according to the features of the particular application so as to automatically establish the network connection for the application. An example system comprises: an application analysis module for analyzing various network applications and for collecting various application connectivity feature data on determining a appropriate network connection for a particular application; databases for storing the various application connectivity feature data collected by the application analysis module; a connection command module used for determining a appropriate network connection for a particular application on the basis of the application connectivity feature data stored in the database; and an autonomic connectivity module for automatically establishing the network connection for the application according to the connection commands from the connection command module.

### TECHNICAL FIELD

The present invention relates to the field of network connection techniques, and more particularly, to automatically establishing network connections according to the features of various kinds of network applications and a user's preferences for various kinds of network applications.

### BACKGROUND OF THE INVENTION

With the rapid popularization of the Internet, the number of users accessing the Internet is growing exponentially. In fact, as the media exclaims, networks have already begun to permeate everyday life of people and influence all aspects of the life of people. For example, all around the world, at all times there are a lot of people using the Internet for sending/receiving e-mails, distributing/browsing all kinds of information and attending various forums.

Meanwhile, there have emerged a great deal of companies specialized in providing the Internet services, i.e. the Internet service providers (ISP), which provide the Internet connectivity service to the Internet users for a service charge.

FIG. 1 shows users accessing the Internet through dial-up. As illustrated in FIG. 1, a user 18 connects to an Internet Service Provider (hereafter referred to as ISP) 14 via the public network 16 by dialing up, and ISP 14 connects to the Internet 12 through a dedicated line. Therefore, the user 18 can connect to the Internet 12 via ISP 14.

Usually, different ISPs have different features. For example, ISPs of larger scale have abundant funds, more advanced design hardware and more secure environment for data transmission, but they also have more users, and thus their lines are busier. As contrast, ISPs of smaller scale may sometimes not be able to provide services users want. Besides, at present different ISPs have different tariffs of fees. Some of them only collect fixed monthly service fees, which is advantageous to the users who would access Internet everyday; some others collect hourly service fees varying dependent on the corresponding time segments, for example, the late night hours being cheaper and the evening hours being more expensive; and more ISPs collect fixed hourly service fees. Generally, users tend to choose cheaper ISPs, but they often find those ISPs' lines being extremely busy, and repetitive dialing is needed. In addition, all ISPs may also continuously adjust their service contents and service fee standards.

Therefore, it is difficult for a network user to choose a right ISP. Most users would want to have a mechanism, which can help them in real time and dynamically select a appropriate ISP, so that they can get the satisfactory service at a lower price.

US Patent No. 2002/0010915 discloses such a mechanism. As shown in FIG. 2, the mechanism provides a server 60 between multiple ISP 14 and multiple users 18. The server 60 can select a appropriate ISP for a user according to his requirements. When a user has established a connection to the server 60 via dial-up, the server 60 selects an ISP according to the user's requirements, and then connects to the selected ISP meeting the user's requirements via dial-up in the same way. After having established the connection between the user 18 and server 60 and the connection between the server 60 and ISP 14, the user 18 will be able to use various applications on the Internet.

However, there are the following disadvantages in the above mechanism. First, this mechanism selects an ISP according to the user's requirements. The specific way of doing this comprises the step of storing a table such as shown in the FIG. 3 and the step of selecting an ISP 14 meeting the user's requirements stored in the table (e.g. the user requires the lowest price) when the server receives a connection request from a user 18. However, the end goal of the user in establishing a network connection is to use various applications on the Internet, such as sending/receiving e-mails, distributing/browsing all kinds of information and attending various online forums. Generally, different applications have different features, and the user will have different requirements in respect to different applications. For example, when sending/receiving e-mails the network connection provided by the ISP is preferably of large throughput, and in the case of taking part in various online forums the network connection provided by the ISP is preferably also of low delay. Usually, different ISPs have different features, and they are applicable to different applications respectively. The wish of the user is to choose, according to different applications, an ISP appropriate for a particular application. The server 60 does not know the detailed application requirement.

Next, currently many kinds of computing devices (e.g. PDAs, portable computers) are equipped with multiple kinds of network adapters, such as modem, IR port, wireless network card etc., allowing the computing devices to be connected to the networks either by using the modem in a wire mode, or by means of a BlueTooth short range wireless network card through a LAN in a wireless mode. In the mechanism as shown in the FIG. 2, it is necessary for the user to choose a network adapter for the network connection. But it is a terrible work for the users who are not familiar with computers to configure properly the parameters of these network adapters.

### SUMMARY OF THE INVENTION

To overcome the above mentioned problems, the present invention provides systems and methods for automatically establishing network connections for an user by selecting in real time and dynamically an ISP and network adapter etc. appropriate for the particular application being currently used by the user, such as sending/receiving e-mails, distributing/browsing all kinds of information and attending various online forums etc., according to the specific features of the application.

According to a first aspect of the invention, there is provided an application-based autonomic connectivity system comprising an application analysis module for analyzing various network applications and collecting various kinds of application connectivity feature data on determining a appropriate network connection for a particular application; databases for storing the application connectivity feature data collected by the application analysis module; a connection command module used for determining a appropriate network connection for a particular application on the basis of the application connectivity feature data stored in the databases; and an autonomic connectivity module for automatically establishing the network connection for the application on the basis of the connection commands from the connection command module.

According to a second aspect of the invention, there is provided an application-based autonomic connectivity method comprising analyzing various network applications and collecting various network application connectivity feature data on determining a appropriate network connection for a particular application; storing the application connectivity feature data collected; determining a appropriate network connection for a particular application on the basis of the application connectivity feature data; and automatically establishing the network connection for the particular application.

### BRIEF DESCRIPTION OF THE DRAWINGS

These and other objects, features, and advantages of the present invention will become apparent upon further consideration of the following detailed description of the invention when read in conjunction with the drawing figures, in which:

FIG. 1 illustrates the establishment of connections with the Internet by users selecting ISPs themselves in the prior art;

FIG. 2 illustrates the establishment of connections with the Internet by a server 60 selecting appropriate ISPs for users in the prior art;

FIG. 3 shows a table illustrating the information contained in a user requirements database and used by the server 60 as shown in FIG. 2 when selecting ISPs for users;

FIG. 4 illustrates the automatic establishment of connections with the Internet for the applications being used by a user according to the invention;

FIG. 5 shows a block diagram of an application-based autonomic connectivity system according to an embodiment of the invention;

FIG. 6A shows a table illustrating the information contained in the application connectivity history database in FIG. 5;

FIG. 6B shows a table illustrating the information contained in the application connectivity requirement database in FIG. 5;

FIG. 6C shows a table illustrating information contained in an ISP database in FIG. 5;

FIG. 6D shows a table illustrating information contained in a proxy server database in FIG. 5;

FIG. 6E shows a table illustrating information contained in a network adapter database in FIG. 5;

FIG. 6F shows a table illustrating information contained in a user requirement database in FIG. 5;

FIG. 7 is a flow chart of message processing of a message processing center in FIG. 5;

FIG. 8 illustrates a specific implementation of the system in FIG. 5; and

FIG. 9 illustrates the processing flow of the application-based autonomic connectivity method according to an embodiment of the invention.

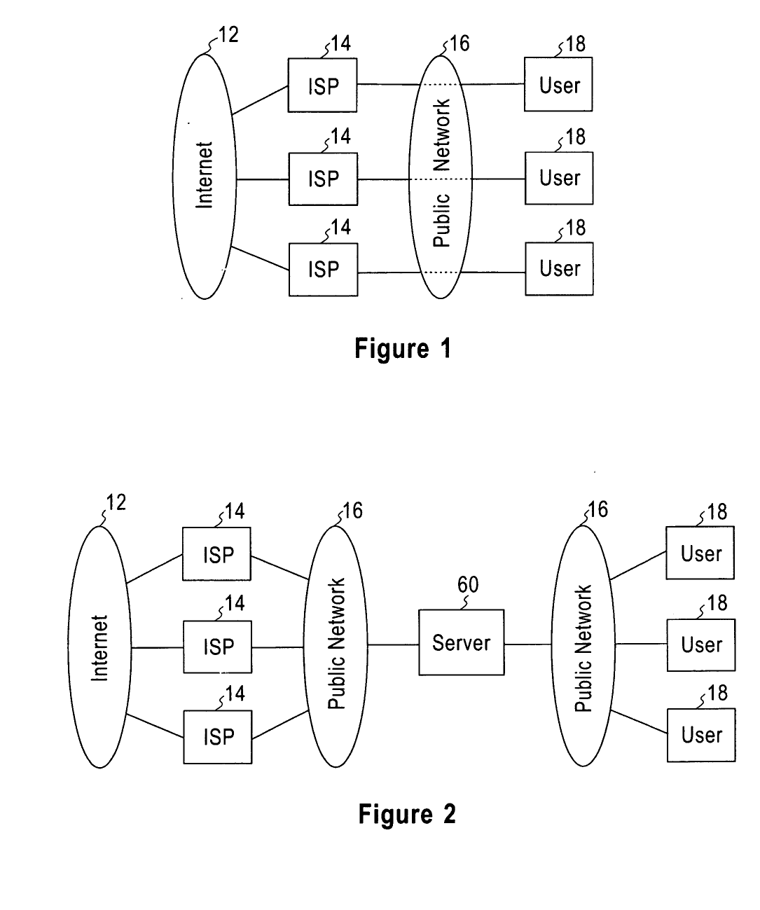

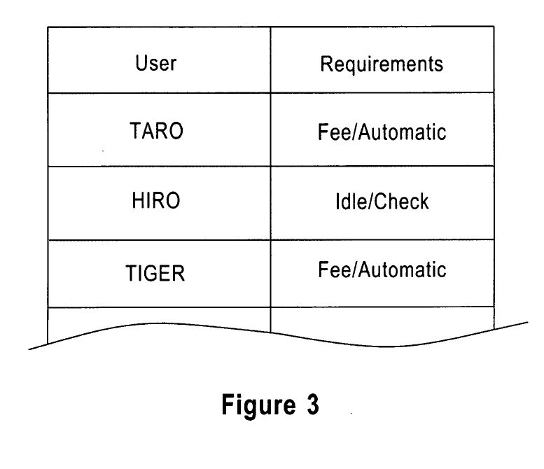

### DETAILED DESCRIPTION OF THE INVENTION

The present invention provides apparatus, systems and methods for automatically establishing network connections for an user by selecting in real time and dynamically an ISP and network adapter etc. appropriate for the particular application being currently used by the user, such as sending/receiving e-mails, distributing/browsing all kinds of information and attending various online forums etc., according to the specific features of the application.

There is herein provided an application-based autonomic connectivity system comprising an application analysis module for analyzing various network applications and collecting various kinds of application connectivity feature data on determining a appropriate network connection for a particular application; databases for storing the application connectivity feature data collected by the application analysis module; a connection command module used for determining a appropriate network connection for a particular application on the basis of the application connectivity feature data stored in the databases; and an autonomic connectivity module for automatically establishing the network connection for the application on the basis of the connection commands from the connection command module.

There is also herein provided an application-based autonomic connectivity method comprising analyzing various network applications and collecting various network application connectivity feature data on determining a appropriate network connection for a particular application; storing the application connectivity feature data collected; determining a appropriate network connection for a particular application on the basis of the application connectivity feature data; and automatically establishing the network connection for the particular application.

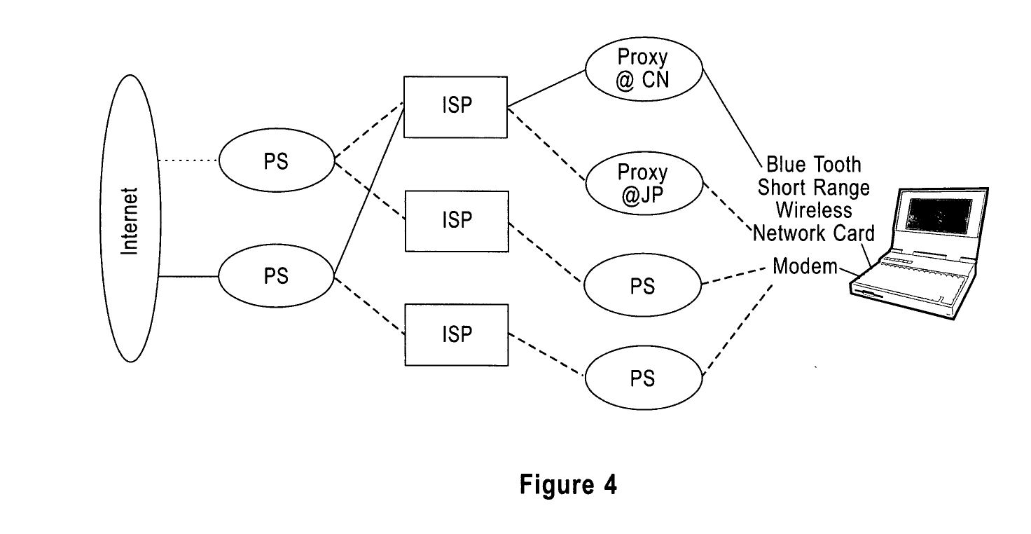

FIG. 4 is a conceptual schematic diagram illustrating automatic establishment of connections with the Internet for an application being used by a user according to the present invention as shown in FIG. 4. The portable computing devices are usually equipped with multiple network adapters, such as a BlueTooth short range wireless network card, IR short range communication network card, modem, USB (Universal Serial Bus) port etc. Some regularities can usually be observed as regards when, where and by what kind of network adapter a user will connect to the networks. For example, when the user sends/receives e-mails in the office during the working hours, he/she would tend to use a BlueTooth short range wireless network card to connect to the Internet through the LAN in the office building, but after work when the user is working in the evening with the portable computing device brought home, the user would tend to use a modem to connect to the Internet. Thus, these regularities can be analyzed and recorded, and a appropriate network adapter can be automatically selected for the particular application being currently used by the user on the basis of the regularities. In order to automatically establish a connection with the Internet according to the application currently being used by the user, apart from selecting a appropriate network adapter and ISP as mentioned above, sometimes it is also necessary to select a proxy server (hereinafter referred to as “PS”). A PS is a type of network server in the Internet that can send access requests to other servers on behalf of its users. By using a cache device, a PS stores the recently accessed documents and data on the local node, and in the case of other users linked to the PS subsequently send requests to access the same documents and data, there will be no need to do searching for them on the Internet, thus decreasing the network traffic. Therefore, the main functions of a PS consist in sending requests on behalf of the users, providing access to web sites outside a firewall from clients inside a firewall, carrying out the monitoring, filtering, recording and reporting etc. of data streams, shielding up the internal structure of the protected network and thus enhancing the network security.

According to the above considerations, as shown in FIG. 4, the application-based autonomic connectivity system according to the present invention is simply to select, on the basis of the features of a particular application being used currently by a user, a network adapter, PS and ISP appropriate for that particular application, and to use them to automatically establish a connection to the Internet for the user.

However, as understood by those skilled in the art, the application-based autonomic connectivity system according to the present invention should not be limited to selecting only the above-mentioned devices and establishing connections to the Internet only through the above-mentioned devices. As described above, the object of the present invention is to automatically establish, on the basis of the features of various applications, the network connections appropriate for the applications, and therefore, all kinds of devices on network connection paths will fall within the scope of the present invention. Besides, the application-based autonomic connectivity system according to the present invention need not select the devices mentioned above one by one, e.g. some portable computing devices may be equipped with only one type of network adapter, or some users may want to select a PS by himself/herself. So, it is clear for those skilled in the art that what the present invention sets forth is a system being able to automatically establish a network connection for a particular application on the basis of the analysis on the application. Although FIG. 4 and other accompanying figures show the ISPs, network adapters and PSs, and describe how to select these devices according to a particular applications, they are only for illustrating the present invention and should not be regarded as a limitation to the present invention.

Now the application-based autonomic connectivity system and method according to the advantageous embodiment of the present invention will be described with reference to the accompanying drawings as follows.

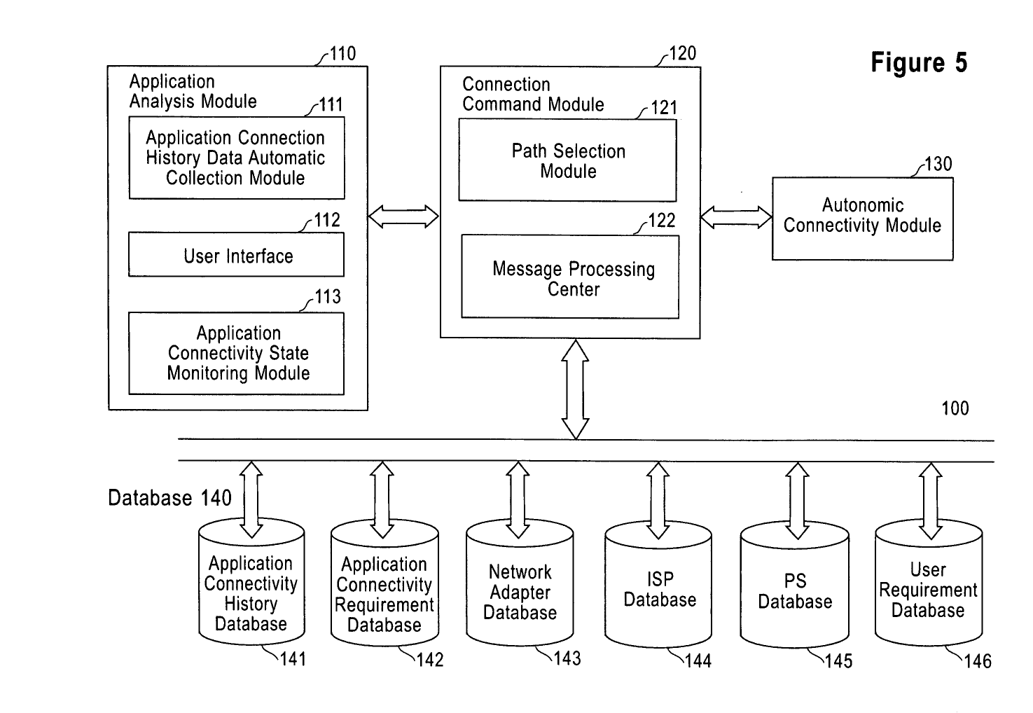

As shown in FIG. 5, an application-based autonomic connectivity system 100 according to the advantageous red embodiment of the present invention comprises: an application analysis module 110, a connection command module 120, an autonomic connectivity module 130, and databases 140. Among them, the application analysis module 110 is used for collecting various application connectivity feature data on determining a appropriate connection for a particular application; the databases 140 are used for storing the application connectivity feature data collected by the application analysis module 110; the connection command module 120 is used for determining a appropriate connection for a particular application on the basis of the application connectivity features data stored in the databases 140; and the autonomic connectivity module 130 is used for automatically establishing the network connection for the application according to the connection commands from the connection command module 120. Among them, the application connectivity feature data may include the application connectivity history data used for describing the features of a particular application and the states of the network connections the application has used; the application connectivity requirement data used for describing the requirements of various kinds of applications with respect to network connections; the data used for describing the features of various network connection devices; and the user requirement data used for describing the requirements of users with respect to various applications. Further, the data used for describing the features of various network connection devices may include the service provider data, PS data or network adapter data.

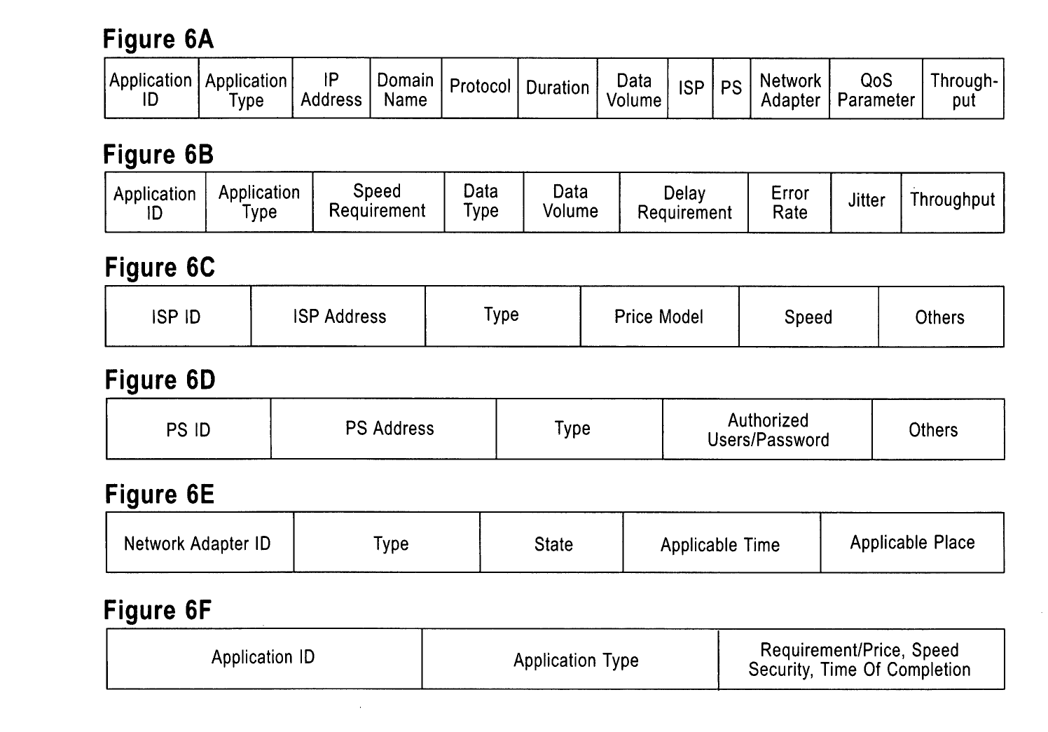

Besides, as shown in FIG. 5, in the application-based autonomic connectivity system according to the advantageous red embodiment of the present invention the application analysis module 110 comprises: an application connectivity history data automatic collection module 111, an user interface 112 and an application connectivity state monitoring module 113. In the application-based autonomic connectivity system according to the present invention, the user can either determine the network connection for a particular application by himself as normal, i.e. select a network adapter, ISP and PS by himself, or directly use a particular application, letting the system of the present invention determine a appropriate network connection for the application. When the network connection for the particular application is determined by the user himself, the application connectivity history data automatic collection module 111 monitors the operation of the user, captures and records the features of the particular application currently being used by the user and the state of the network connection currently being used, then sends these data to the connection command module 120, and after the data are processed by the message processing center 122 in the connection command module 120, the data are stored into the corresponding database as the connection history data records of the particular application to be used in the future by the system in determining the network connection for the same or like applications. The application connectivity history data are used for describing the features of a particular application and the states of the network connections having been used by the particular application in the past. For example, as shown in FIG. 6A, the data used to describe the features of the particular application in the application connectivity history data may include: the application ID, application type, IP address, domain name, protocol, duration, data volume etc.; and the data used to describe the states of the network connections having been used by the particular application may include: the ISP, the PS, the network adapter etc. having been used by the application and the QoS (Quality of Service) parameters and throughput of the connections. Among them, the QoS parameters and throughput are detected by the application connectivity state monitoring module 113 and are the data used to describe the state of the network connections during the application is being used by the user, the QoS parameters usually including delay, jitter, error rate etc.

In addition, in the case of the user directly uses a particular application, the application connectivity history data automatic collection module 111 is also used to capture the connection request/DNS (domain name server) request, send the request to the connection command module, which will automatically determine the network connection for the particular application.

The application analysis module 110 also includes a user interface 112 through which the user can input various application connection feature data on determining a appropriate network connection for a particular application, including, for example, application connectivity history data, application connectivity requirement data, network adapter data, ISP data, PS data and user requirement data etc. The above has provided an explanation to the application connectivity history data. And the following will provide a detailed explanation to the application connectivity requirement data, ISP data, PS data, network adapter data, user requirement data, and their functions.

The application connectivity requirement data are used to describe the requirements of various kinds of applications for their network connections. Usually, applications can be classified into different types, and the different types of applications will have different requirements for their network connections.

For example, “chatting”, “telnet” etc. belong to the interactive flow type, and the requirements of these applications for their network connections are minimized delay, faultless, and small throughput; “ftp”, “E-mail” etc. belong to the bulk-data flow type, and the requirements of these applications for their network connections are faultless and large throughput; browsing information on the web belongs to the short-term flow type, and the requirements of these applications for their network connections are faultless, large throughput, low delay; VoD belongs to the multimedia flow type, and the requirements of these applications for their network connections are low jitter, large throughput, and tolerant of a small number of faults.

The application-based autonomic connectivity system according to the present invention is simply to analyze the type to which a particular application belongs, and select the network connection appropriate for the particular application, on the basis of the requirements of the type of applications for the network connections. FIG. 6B shows an example of the application connectivity requirement data. As shown in FIG. 6B, the application connectivity requirement data include, e.g. the application type, speed requirement, data type, data volume, QoS requirement (delay, fault-tolerance, jitter etc.) and throughput requirement.

As shown in FIG. 6C, the ISP data are used for describing the features of an ISP such as the ISP ID, ISP address, type, price model, speed etc.

As shown in FIG. 6D, the PS data are used for describing the features of an PS such as the PS ID, PS address, PS type, authorized users/passwords.

The network adapter data are used for describing the features of network adapters installed in an user's computing devices, for example, as shown in FIG. 6E, including the network adapter ID, network adapter address, type, applicable time, applicable place etc. For the same application, different network adapters may be selected depending upon different times and places, for example, in the same case of sending/receiving e-mails, if an user is at home, the user usually connects to the web through a modem, but if in the office the user tends to use a BlueTooth short range wireless network card to connect to the network. So the network adapter data includes the two fields of applicable time and applicable place.

All the data mentioned above (including application connectivity requirement data, ISP data, PS data, and network adapter data) can be inputted through the user interface 112 by the user. So, in the application-based autonomic connectivity system according to the present invention, it is not only possible to collect automatically by using the application connectivity history data automatic collection module 111 the states of the connections being used by various kinds of applications as history records for later use by the system in determining the network connections for the same or like applications, but also possible to input all the data on determining a appropriate connection for a particular application through the user interface 112 for use by the system.

It should be noted that the user can also input the application connectivity history data and user requirement data through the user interface 112. Usually, the application connectivity history data are collected by the application connectivity history data automatic collection module 111, but in the case of the user wants to set the network connection accurately and directly for a particular application so that the system can thereafter determine the network connections for the same or like applications on the basis thereof, the user can also input application connectivity history data through the user interface 112. In addition, in the case of multiple network connections all satisfy the requirements of some particular application, the system can use the user requirement data to determine the final network connection. The user requirement data describe which aspects of a particular application are emphasized by the user, for example, the price, speed, security, time of completion etc. FIG. 6F shows an example of such user requirement data.

Besides, as shown in FIG. 5, the application analysis module 110 also includes an application connectivity state monitoring module 113. After the system has automatically established the network connection for a particular application, this module monitors the connection being used by the application, i.e. measures the QoS parameters and throughput of the connection, the QoS parameters including the delay, error rate, jitter etc. The application connectivity state monitoring module 113 sends the measured data to the connection command module 120. On the basis of the requirements of that kind of applications stored in the application connectivity requirements database, the connection command module 120 determines whether the current connection satisfies the requirements of the application, and if it does, records the connection features of the application in the application connectivity history database as history records for the system to use later in automatically determining the network connection for other applications. If the connection command module 120 determines that the current connection does not satisfy the requirements of the application, then it redetermines a connection for the application.

The above describes in detail the composition of the application analysis module 110, and at the same time of introducing the application connectivity history data automatic collection module 111, user interface 112 and application connectivity state monitoring module 113, the contents and functions of the data in all databases of the system (including the application connectivity history database, application connectivity requirement data, ISP database, PS database, network adapter database and user requirement database) are also explained. The following will give a detailed description of the composition of the connection command module 120 and how the connection command module 120 determines the network connection for a particular application on the basis of the data stored in the above databases.

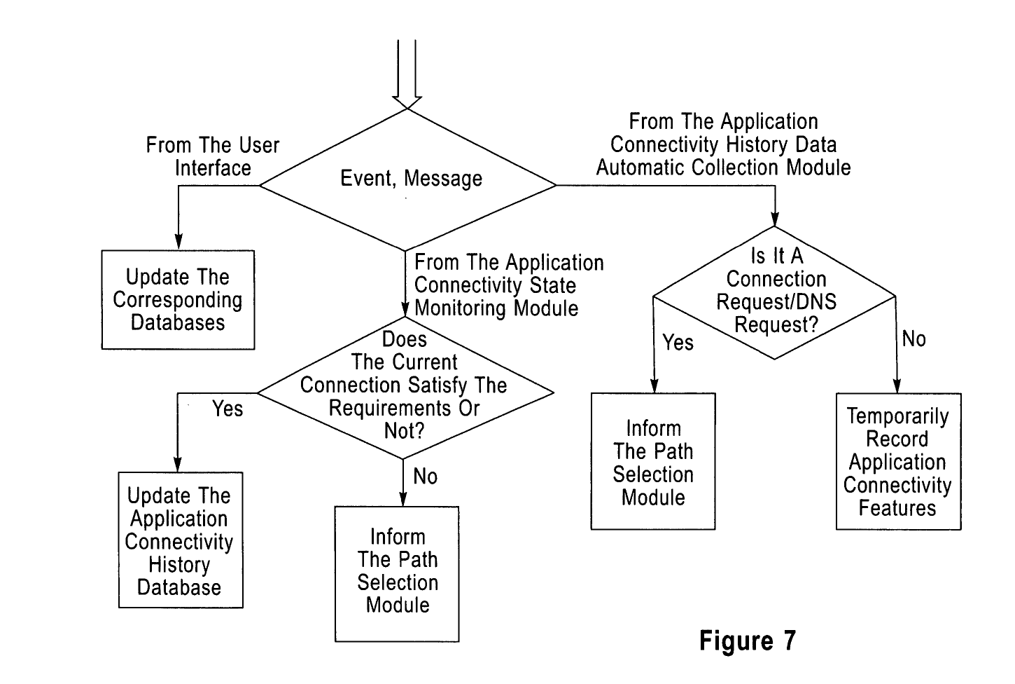

As shown in FIG. 5, the connection command module 120 includes a path selection module 121 and a message processing center 122. As shown in FIG. 7, the message processing center 122 processes the messages from each part of the application analysis module 110 according to the types of the messages (events). If the message processing center determines that the received message is from the user interface 112, then the message processing center 122 will use the data inputted by the user to update the records of the relevant databases in the system. If the message processing center 122 determines that the received message is from the application connectivity history data automatic collection module 111, then the message processing center 122 will determine further whether the received message is a connection request/DNS request, and if it is, then inform the path selection module 121 to determine the network connection for the request, that is, to select a appropriate network connection for the request (application). If it is not a connection request/DNS request, then it must be the application connectivity history data collected automatically by the application connectivity history data automatic collection module. It should be noted that in this case the features and connection features of the application will be recorded only temporarily, and only when the data from the application connectivity state monitoring module 113 have shown that the current connection satisfies the requirements of the application (by comparing the received QoS parameters etc. with the content in the application connectivity requirements database), will the application connectivity features data be used to update the application connectivity history database. Moreover, at the time of updating the application connectivity history database, if there is already a connection used for the application in the database, then it is necessary to determine whether the connection is better than the existing connection, and only in the case of the connection is better than the existing connection, the records of the application connectivity history database will be updated. As to how to determine whether the connection is better than the existing connection or not, the usual method is first to determine the type of the application and find out the aspects mainly emphasized by the user with respect to this type of applications in the user requirement database, and then determine which of the two connections is better in these aspects.

In addition, when the message processing center 122 determines that the data are from the application connectivity state monitoring module and determines that the current connection does not satisfy the requirements, then it informs the path selection module 121 to re-select a connection for the application.

The above has described the message processing center 122 in the connection command module 120, and the following will describe the path selection module 121. After the path selection module 121 receives a connection request/DNS request from the message processing center 122, it will first search for the application connectivity history data corresponding with the application (the same or like) in the application connectivity history database, and if there is such data, then it will send the application connectivity history data to the autonomic connectivity module 130 and command the latter to establish automatically the network connection for the application.

If the path selection module 121 has not found any application connectivity history data corresponding with the application in the application connectivity history database, then it needs first to determine the type of the application and to find the requirements of the type of the application from the application connectivity requirement database, and then to find the network connection satisfying the requirements in the ISP database, PS database and network adapter database, that is, to determine a appropriate ISP, PS and network adapter, and to inform the autonomic connectivity module 130 of the selected ISP, PS and network adapter to command the autonomic connectivity module 130 to establish automatically the network connection for the application. In the case of two or more network connections all satisfy the requirements of the particular application at the same time, the path selection module 121 can determine an optimal network connection on the basis of the requirements of the users for this kind of applications stored in the user requirement database, i.e. which aspects are emphasized by the users with respect to this kind of applications, such as, price (selecting the most economical access path), speed (selecting the fastest access path), security (selecting the safest access path) time of completion (selecting the access path satisfying the time requirement) etc.

The connection command module 120 has been described above. The system shown in FIG. 5 also includes an autonomic connectivity module 130 used for setting, according to the commands from the connection command module 120, the corresponding network devices to establish automatically the network connection.

In addition, in the system, the application connectivity state monitoring module 113 can also monitor the network connection state of an application, and once a session is completed, inform the connection command module 120 to re-select a more appropriate network connection for the application, e.g. a cheaper connection. For example, the 163 and 263 web sites have the same charging standards for the normal time segments, but the 163 offers a cheaper price after 21:00. So, if the application connectivity state monitoring module 113 has detected the end of a session of an application at about 21:00 in the evening, it will inform the connection command module to redetermine the connection for the application, and the ISP in the network connection thus determined this time will probably be the 163.

The above provides a detailed description of the composition of the application-based autonomic connectivity system according to the advantageous embodiment of the present invention with reference to the accompanying drawings. It is obvious to those skilled in the art that it is possible to realize the present invention in various specific implementations on the basis of the foregoing content. As an illustrative example of a specific implementation, the following will give a description of how to realize the above described application-based autonomic connectivity system according to the present invention on the basis of existing software packages such as Access Connectivity from IBM, IE, Winsock and NDIS from Microsoft. First, the functions of these software packages will be given respectively.

Access Connectivity from IBM: a kind of access connectivity software which provides a connection profile and allows an user to complete the selection to an ISP and network adapter in a single step.

IE from Microsoft: a client-side network application from Microsoft, by which a user can utilize various applications on the Internet, such as sending/receiving e-mails, browsing/distributing all kinds of information and attending various online forums.

Winsock: A Windows-based application programming interface (API) for developers to transfer data between application programs (e.g. IE, Navigator) and TCP/IP protocol stacks. Using Winsock, the manufacturers using different protocols can design Winsock programs based on their own TCP/IP protocol stacks so that the application programs using different protocols can communicate with each other through the Winsock interface. It extends the functions of API and makes possible the information transfer between Windows-based applications and network-based applications.

NDIS: a network driver interface specification.

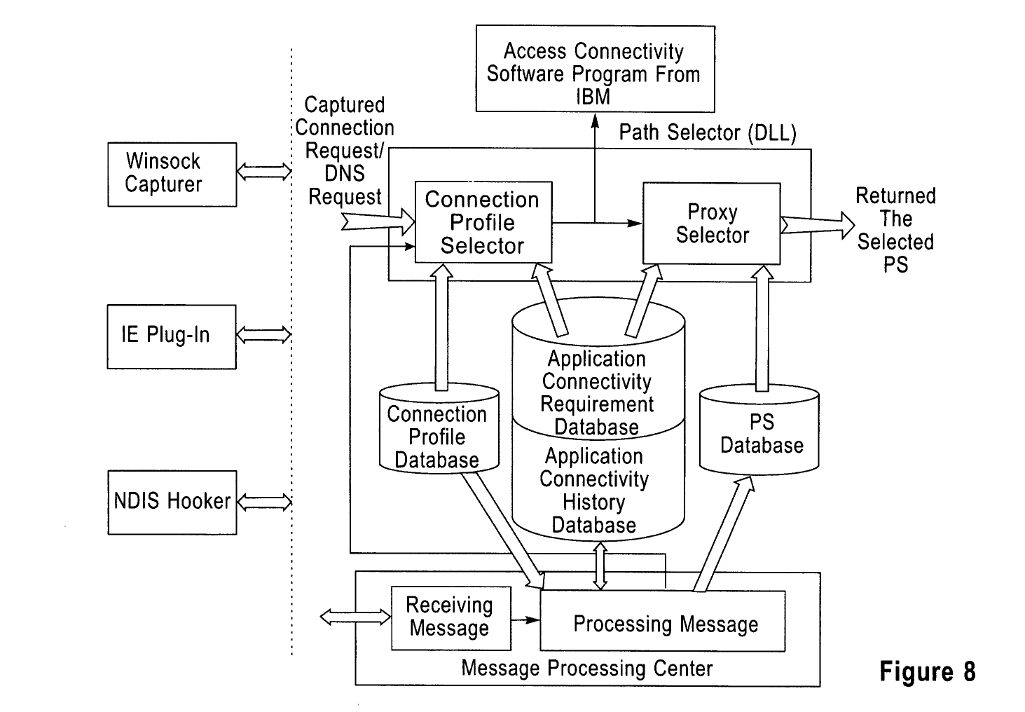

FIG. 8 illustrates a specific example of the implementation of the application-based autonomic connectivity system according to the present invention. In the example shown in FIG. 8, using the following existing software programs: Access Connectivity from IBM, Winsock, IE and NDIS from Microsoft.

Since most users now use the client software IE provided by Microsoft to utilize various applications on the Internet, in the example shown in FIG. 8 an IE plug-in is designed to offer a simple user interface so that an user can select and configure a PS. As to the selection and configuration of an ISP or network adapter, they can be done in the software program Access Connectivity from IBM.

The Winsock capturer is used for capturing all Windows sockets, i.e. for capturing connection requests/DNS requests, and can invoke the path selector provided in the connection command center. When the path selector has returned a selected PS, this PS will be used. In addition, the Winsock capturer can also be used to measure the QoS parameters of every application.

The NDIS hooker is used for computing the throughput of networks.

Since in the specific example of the implementation shown in FIG. 8, using the software program Access Connectivity from IBM which provides some profiles, the user can complete the selection to an ISP and network adapter in one step by using the software. Therefore, the ISP database and the network adapter database as shown in FIG. 5 are combined into one connection profile database. As shown in FIG. 8, in the example, the path selector includes a connection profile selector and a proxy selector, wherein the connection profile selector is used for selecting an ISP and network adapter, and the proxy selector is used for selecting a PS. On the basis of the QoS parameters and cost etc., the connection profile selector in the path selector determines for a particular application a network connection appropriate for the application and capable of meeting the requirements of the user for the type of applications, i.e. on the basis of the application connectivity requirement database, application connectivity history database and connection profile, selects the ISP and network adapter appropriate for the application, and sends the selected ISP and network adapter to the Access Connectivity which will establish a network connection for the application. In addition, the path selector is a dynamic link library, which can be invoked by, for example, the Winsock capturer. Thus, when it is needed to determine a PS appropriate for an application and capable of meeting the requirements of a user for the kind of applications, the Winsock capturer can invoke the path selector. When the path selector has returned a selected PS, the PS will be used for establishing a network connection for the particular application. Among them, the proxy selector in the path selector selects a PS on the basis of the connection requirement database, application connectivity history database and PS database. As seen from the implementation, the final automatic connection is accomplished together by the Access Connectivity and the Winsock capturer. Since the functions of the message processing center shown in FIG. 8 are the same as those shown in FIG. 5, the detailed description on them has been omitted.

The above, in reference to the accompanying drawings, provides a detailed description of the application-based autonomic connectivity system according to the present invention and a specific implementation of the system utilizing some existing software.

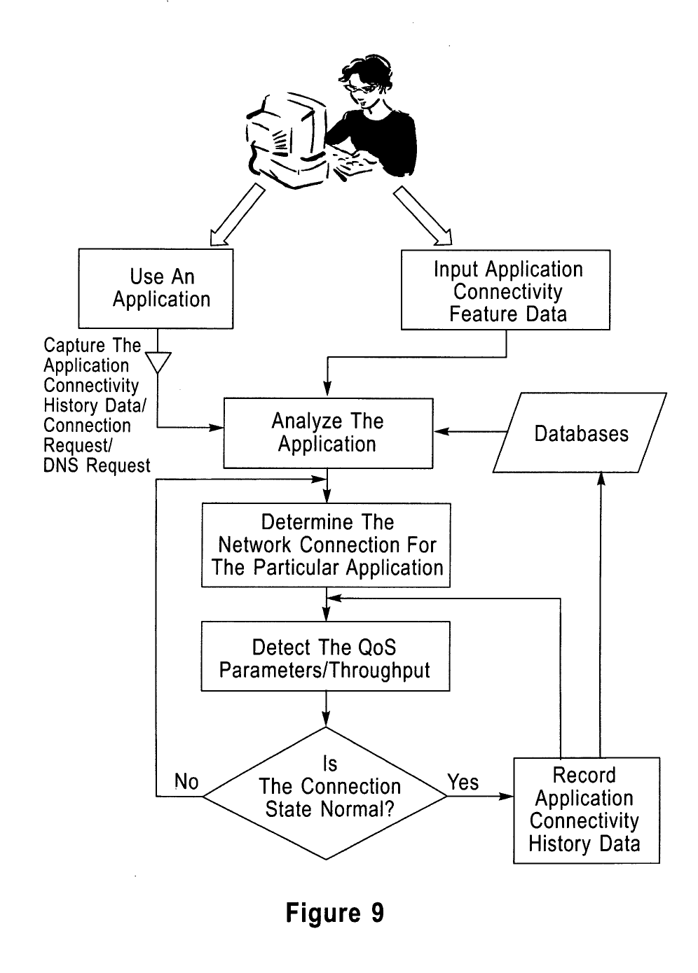

FIG. 9 is a flow chart illustrating the application-based autonomic connectivity method according to the advantageous embodiment of the invention. As shown in FIG. 9, the user can input the application connection feature data or directly use a particular application. This method comprises the following steps: collecting various application connectivity feature data on determining a appropriate network connection for a particular application; storing the application connectivity feature data collected; determining a appropriate network connection for a particular application on the basis of the application connectivity feature data; and automatically establishing the network connection for the application. In addition, the network connection state of the application is also monitored and the QoS parameters thereof are tested, to determine whether or not the connection satisfies the requirements of the application and if it does, the application connectivity feature data will be recorded into the databases, otherwise a appropriate network connection will be re-selected for the application.

Although the above has described in detail in reference to the accompanying drawings the application-based autonomic connectivity system and method according to the advantageous embodiment of the invention, various changes and modifications in a wide range will be without departing from the spirit and scope of the invention, so the invention is intended to cover all these changes and modifications.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

1. An application-based autonomic connectivity system, comprising:
an application analysis module for analyzing various network applications and collecting various network application connectivity feature data on determining a appropriate network connection for a particular application;
databases for storing the application connectivity feature data collected by the application analysis module;
a connection command module for determining an appropriate network connection for a particular application on the basis of the application connectivity feature data stored in the databases; and
an autonomic connectivity module for automatically establishing the network connection for the application on the basis of the connection commands from the connection command module.

2. The system according to claim 1, wherein the application analysis module is used for collecting one or more of the following application connectivity feature data: the application connectivity history data used for describing the features of a particular application and the states of the network connections having been used by the particular application; the application connectivity requirement data used for describing the requirements of various kinds of applications for their network connections; and the network connection devices data used for describing the features of various network connection devices.

3. The system according to claim 2, wherein the network connection devices data include one or more of the following data: service provider data, proxy server data and network adapters data.

4. The system according to claim 2, wherein the application analysis module is also used for collecting the following application connectivity features data: user requirement data used for describing the requirements of users for various kind of applications.

5. The system according to claim 1, wherein the application analysis module includes an application connectivity history data automatic collection module used for monitoring the operation of the user, capturing and recording the features of the application currently being used by the user and the state of the network connection currently being used as the connection history data of the particular application.

6. The system according to claim 1, wherein the application analysis module includes a user interface through which the user can input various kinds of application connectivity feature data.

7. The system according to claim 1, wherein the application analysis module includes an application connectivity state monitoring module used for measuring the QoS parameters or network throughput with respect to every application currently being used by the user.

8. The system according to claim 1, wherein the databases includes one or more of the following databases: an application connectivity history database used for storing application connectivity history data; an application connectivity requirement database used for storing application connectivity requirement data; and a network connection device database used for storing network connection device data.

9. The system according to claim 8, wherein the network connection device database includes one or more of the following databases: a service provider database; a PS database; and a network adapter database.

10. The system according to claim 8, wherein the databases further includes a user requirement database used for storing the user's requirements.

11. The system according to claim 1, wherein the connection command module includes a path selection module for determining a appropriate network connection for a particular application on the basis of the data in the databases.

12. The system according to claim 11, wherein when two or more network connections all satisfy the requirements of the particular application, the path selection module determines an optimal network connection on the basis of the user requirement data.

13. The system according to claim 1, wherein the connection commands module includes a message processing center used for receiving various messages from the application analysis module and processing these messages according to the types of the messages.

14. The system according to claim 13, wherein if the message processing center determines that the message received from the application analysis module is application connectivity feature data, the message processing center will carry out updating operations on the corresponding databases.

15. The system according to claim 14, wherein if the message processing center determines that the message received from the application analysis module is application connectivity history data, the message processing center will only store the data temporarily without updating the database immediately.

16. The system according to claim 13, wherein if the message processing center determines that the message received from the application analysis module is a connection request/DNS request, it informs the path selection module to determine a appropriate network connection for the application.

17. The system according to claim 13, wherein if the message processing center determines that the message received from the application analysis module is QoS parameters or network throughput, the message processing center determines whether or not the connection satisfies the requirements of the application and if it does, updates the data in the application connectivity history database, otherwise informs the path selection module to redetermine an appropriate network connection for the application.

18. An application-based autonomic connectivity method, comprising the following steps:
analyzing various network applications and collecting various application connectivity features data on determining an appropriate network connection for a particular application;
storing the application connectivity feature data collected;
determining a appropriate network connection for a particular application on the basis of the application connectivity feature data; and
automatically establishing the network connection for the particular application.

19. A computer program product comprising a computer usable medium having computer readable program code means embodied therein for causing an application-based autonomic connectivity system, the computer readable program code means in said computer program product comprising computer readable program code means for causing a computer to effect the functions of:
an application analysis module for analyzing various network applications and collecting various network application connectivity feature data on determining a appropriate network connection for a particular application;
databases for storing the application connectivity feature data collected by the application analysis module;
a connection command module for determining an appropriate network connection for a particular application on the basis of the application connectivity feature data stored in the databases; and
an autonomic connectivity module for automatically establishing the network connection for the application on the basis of the connection commands from the connection command module.

20. An article of manufacture comprising a computer usable medium having computer readable program code means embodied therein for causing application-based autonomic connectivity, the computer readable program code means in said article of manufacture comprising computer readable program code means for causing a computer to effect the steps of:
analyzing various network applications and collecting various application connectivity features data on determining an appropriate network connection for a particular application;
storing the application connectivity feature data collected;
determining a appropriate network connection for a particular application on the basis of the application connectivity feature data; and
automatically establishing the network connection for the particular application.

21. A program storage device readable by machine, tangibly embodying a program of instructions executable by the machine to perform method steps for causing application-based autonomic connectivity, said method steps comprising the steps of claim 18.
